(19) United States
(12) Patent Application Publication
(10) Pub. No.: US 2009/0167949 A1
(43) Pub. Date: Jul. 2, 2009

(54) Method And Apparatus For Performing Edge Blending Using Production Switchers

(76) Inventors: David Alan Casper, Nevada City, CA (US); Bret Michael Jones, Rough & Ready, CA (US); Neil Raymond Olmstead, Nevada City, CA (US)

Correspondence Address: Thomson Licensing LLC, P.O. Box 5312, Two Independence Way, PRINCETON, NJ, 08543-5312, US

(21) Appl. No.: 12/225,136

(22) PCT Filed: Mar. 28, 2006
(86) PCT No.: PCT/US06/11049

§ 371 Date: Sep. 15, 2008

(51) Int. Cl. H04N 9/74

(52) U.S. Cl. 348/584; 348/E09.055

(57) ABSTRACT

A video production switcher comprises a number of mix effects units, each mix effects unit providing a video output signal for use in displaying images on a display; a memory for storing an image; and a controller for (a) mapping the stored image to a global space, the global space associated with the display, and (b) for determining a number of viewports in the global space, each viewport associated with one of the number of mix effects units, a portion of the stored image and a screen of the display; and wherein those viewports associated with adjacent screens of the display overlap.

### BACKGROUND OF THE INVENTION

The present invention generally relates to video production systems and, more particularly, to the production of video effects.

Producers, or stagers, of live events may enhance these events by providing a high quality video experience that is delivered on as large a projection screen as possible to the audience. Typically, the projection screen is arranged in back of, or above, the location of the live events and multiple video outputs are projected, often side-by-side onto the projection screen. Typically, the side-by-side projected images cannot be just butted together as slight variances in image brightness, color, etc., will not create an overall seamless widescreen image. As such, in a large projection screen system, images may overlap slightly, about 5-10% of the image width. This is illustrated in FIG. 1. An image 11 (the boundary of which is shown in dashed-line form) is divided into an image A and an image B for projection onto a projection screen 21, which comprises two horizontally aligned smaller screen portions 21-1 and 21-2. The image A is projected such that the image A extends onto a piece of screen portion 21-2 as illustrated by arrow 23. Likewise, the image B is projected such that the image B extends onto a piece of screen portion 21-1 as illustrated by arrow 24. Overlap region 22 represents where the images overlap. Since the images overlap, it is likely that overlap region 22 will be brighter than the images on the rest of the projection screen. This brightness effect is represented by the stippling in overlap region 22. As a result, the overlap region will be visible—and distracting—to the spectators and detract from their video experience. As such, there is a need to be able to ramp down the intensity of the video outputs in the overlap region so that the overlap region does not appear brighter than the images on the rest of the projection screen. This is referred to as horizontal edge blending.

Unfortunately, a conventional video production switcher cannot provide overlapping sources and blending regions. As such, video material with overlapped horizontal images (also referred to as overlapped horizontal edges) must be pre-rendered with horizontal blending regions before application to the video switcher. External pre-rendering of the video material externally can be performed with any one of several currently available rendering systems, such as Avid, Macromedia, and After Effects.

However, a number of vendors provide specialized equipment that are directly targeted at the use of horizontally aligned portions. For example, systems like the Montage from Vista and the Encore from Barco/Folsom provide horizontal blending. In addition, Barco/Folsom also makes the BlendPro device, which takes discrete video inputs and forms an overlap lap region with horizontal blending. Although the BlendPro device has inputs that handle live video, the BlendPro is really only of use for blending pre-rendered video material that is divided into separate portions before application to the BlendPro, which then recombines the separate portions. In particular, video, or graphic, material is created off-line to create one image. This image is then sliced into rectangular horizontal portions for display on horizontal portions of a project screen, where the appropriate edges are horizontally blended. These horizontal portions are then applied to the BlendPro.

### SUMMARY OF THE INVENTION

In accordance with the principles of the invention, a video production switcher stores an image and maps viewports to the stored image for use in displaying the image, wherein at least two viewports overlap.

In an embodiment of the invention, a video production switcher comprises a number of mix effects units (M/Es), each M/E providing a video output signal for use in displaying images on a display; a memory for storing an image; and a controller for (a) mapping the stored image to a global space, the global space associated with the display, and (b) for determining a number of viewports in the global space, each viewport associated with one of the number of mix effects switchers, a portion of the stored image and a portion of the display; and wherein those viewports associated with adjacent portions of the display overlap.

### BRIEF DESCRIPTION OF THE DRAWINGS

FIG. 1 illustrates an overlap region on a projection screen comprising a number of smaller horizontally arranged screen portions;

FIG. 2 shows an illustrative embodiment of a video production switcher in accordance with the principles of the invention;

FIG. 3 shows an illustrative flow chart-for use in a video production switcher in accordance with the principles of the invention;

FIGS. 4-9 further illustrate the principles of the invention;

FIG. 10 shows another illustrative embodiment of a video production switcher in accordance with the principles of the invention;

FIGS. 11 and 12 shows mappings of the Ms of FIG. 10 to the screen in accordance with the principles of the invention;

FIGS. 13 and 14 show an illustrative graphical user interface for use in accordance with the principles of the invention; and

FIG. 15 shows an extension of the inventive concept to non-overlapping viewports.

### DETAILED DESCRIPTION

Other than the inventive concept, the elements shown in the figures are well known and will not be described in detail. Also, familiarity with video production is assumed and is not described in detail herein. In this regard, it should be noted that only that portion of the inventive concept that is different from known video production switching is described below and shown in the figures. As such, familiarity with mix effects (M/E) devices, blending (soft cropping), digital video effects (DVE) channels, mixer bus, keyframes, transform matrix calculations for images, etc., is assumed and not described herein. It should also be noted that the inventive concept may be implemented using conventional programming techniques, which, as such, will also not be described herein. Finally, like-numbers on the figures represent similar elements and representations in the figures are not necessarily to scale.

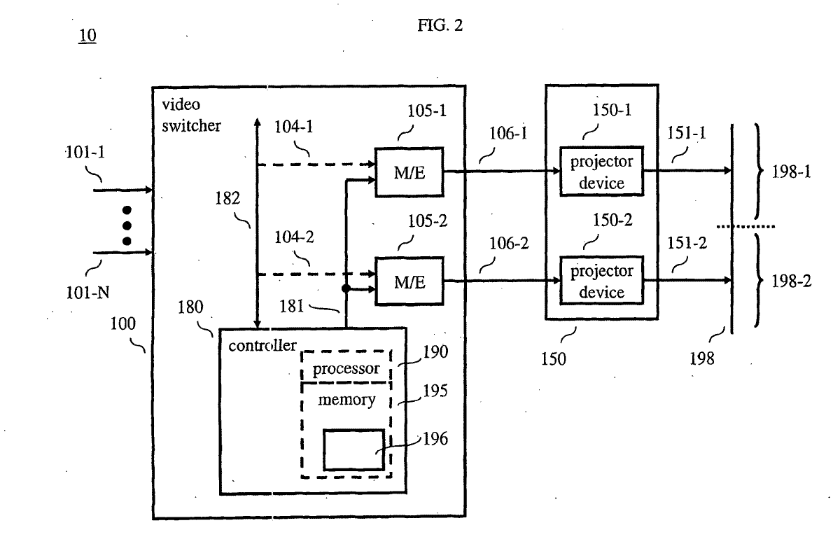

An illustrative embodiment of a video system 10 in accordance with the principles of the invention is shown in FIG. 2. As noted above, only those portions of video system 10 relative to the inventive concept are shown. For example, video production switcher 100 may include one, or more, switching matrices as known in the art for enabling the selection and switching of a variety of video signals among various elements of video production switcher 100 to achieve particular effects and also to enable the selection of particular video signals to be provided as the main (also referred to as the program, or PGM) output of video production switcher 100. However, these one, or more, switching matrices. are not relevant to the inventive concept and, as such, are not shown in FIG. 2.

Video system 10 comprises video production switcher 100, projector 150 and projection screen 198 (also referred to herein as a display). The latter is a wide extended screen and comprises a number of smaller screen portions as represented by screen portions 198-1 and 198-2 for displaying video content provided by video display signals 151-1 and 151-2, respectively. In this regard, projector 150 comprises a number of projection devices 150-1 and 150-2 for providing the particular video display signals to the respective portion of projection screen 198. Other than the inventive concept, video production switcher 100 switches video input signals from one, or more, sources, as represented by input signals 101-1 through 101-N, to one or more outputs, as represented by screen output signals 106-1 and 106-2 for eventual display on a respective portion of projection screen 198. The video input sources may be, e.g., cameras, video tape recorders, servers, digital picture manipulators (video effects devices), character generators, and the like. As known in the art, the screen output signals are representative of PGM signals as known in the art, i.e., the final output signal of the video production switching equipment.

Turning now to video production switcher 100, this element comprises a controller 180 and a number of mix effects units (M/E), 105-1 and 105-2. Each M/E, 105-1 and 105-2, receives one, or more, video signals (as represented by respective video signals 104-1 and 104-2 in dashed-line form) for processing to provide screen output signals 106-1 and 106-2, respectively. Each M/E is controlled (via control signaling 181) by controller 180, which is a software-based controller as represented by processor 190 and memory 195 shown in the form of dashed boxes in FIG. 2. In this context, computer programs, or software, are stored in memory 195 for execution by processor 190. The latter is representative of one or more stored-program control processors and these do not have to be dedicated to the controller function for the M/E devices, e.g., processor 190 may also control other functions and or devices (not shown) of video production switcher 100. Memory 195 is representative of any storage device, e.g., random-access memory (RAM), read-only memory (ROM), etc.; may be internal and/or external to video production switcher 100; and is volatile and/or non-volatile as necessary.

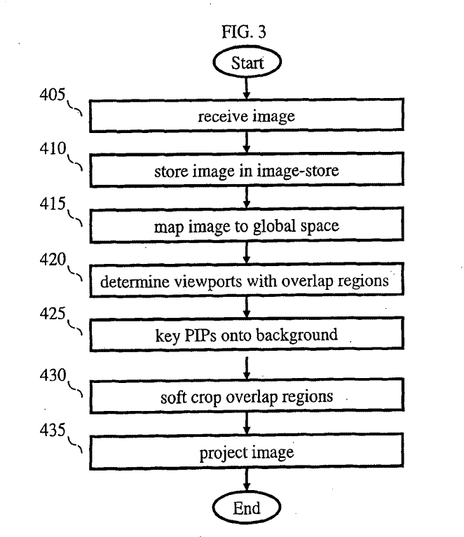

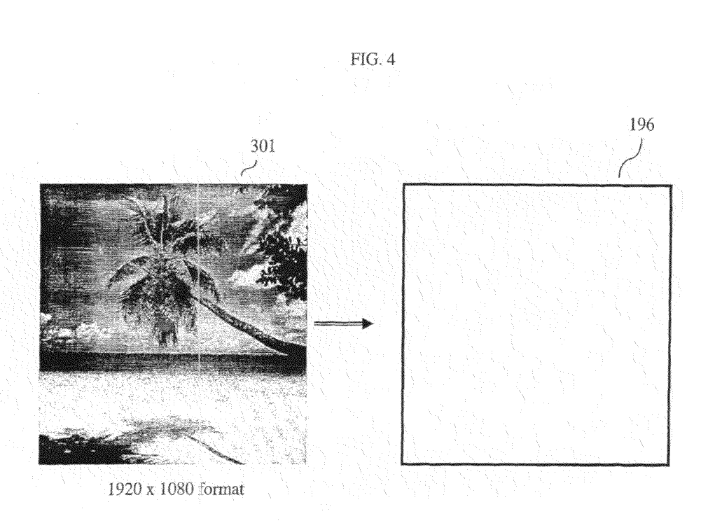

In accordance with the principles of the invention, memory 195 comprises a portion 196 for storing an image (also referred to herein as an image-store, still-store or clip-store). Reference at this time should also be made to FIG. 3, which shows an illustrative flow chart for use in video production switcher 100 in accordance with the principles of the invention. In step 405 of FIG. 3, controller 180 receives an image for display on the projection screen. For example, a content creator makes an image (for use as a background) that is downloaded into image-store 196. The image can, e.g., be received, via one of the input signals 101-1 through 101-N. In this example, a background image 301 is received for storage, in its entirety, in image-store 196 as illustrated in FIG. 4. Illustratively, image-store 196 is designed to accept images of any size up to the maximum space available in image store 196. In this example, it is assumed that the picture format of image 301 is 1920×1080, i.e., 1920 pixels wide by 1080 pixels high, and that image-store 196 is big enough to store an image of this size.

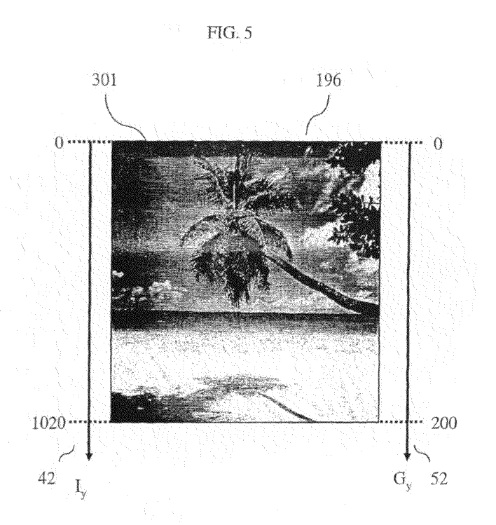

In step 410 of FIG. 3, controller 180 stores the image in image-store 196. In step 415, and in accordance with the principles of the invention, controller 180 maps the image into a projection screen coordinate space (also referred to herein as a global coordinate space or global space). This mapping is illustrated in FIG. 5 for image 301. For this example, it is assumed that the coordinate space is Cartesian. However, the inventive concept is not so limited. For illustration purposes, only one dimension is described for this example, e.g., the y-dimension (which is associated herein with “height”). Extension of the inventive concept to two, or three, dimensions is straightforward. As shown in FIG. 5, y-dimension axis 42 represents the height dimension of the image in pixels, from a value of I_{y}=0 in the top left corner to a maximum value of I_{y}=1020 in the lower left corner. The height of the image in pixels is mapped to the height of projection screen 198 as represented by y-dimension axis 52. For this example, it is assumed that the height of projection screen 198 is G_{y}=200 elements. Similar comments apply to the x-dimensions (not shown). For the purposes of this example, it is assumed that the width and height of projection screen 198 corresponds to the effective display width and height, i.e., the area of projection screen 198 that is capable of showing an image (as compared to the actual physical width and height, the area of which may be larger than the effective display area). Illustratively, the global y coordinate value of 0, i.e., G_{y}=0, is mapped to the top edge of projection screen 198 and the global y coordinate value of 200, i.e., G_{y}=200, is mapped to the bottom edge of projection screen 198. As such, in this example, it is assumed that the effective projection screen height is 200 elements high. It should be noted that each “element” of the global space corresponds to either pixels, inches, centimeters, screen unit, etc. Further, the dimensions of project screen 198 are merely illustrative for the purpose of describing the inventive concept. The projection screen may display standard video (e.g., 4:3 video format), high definition video (16:9 video format), etc. However, whether the actual type of “element” represents a pixel, an inch, etc., is irrelevant to the inventive concept.

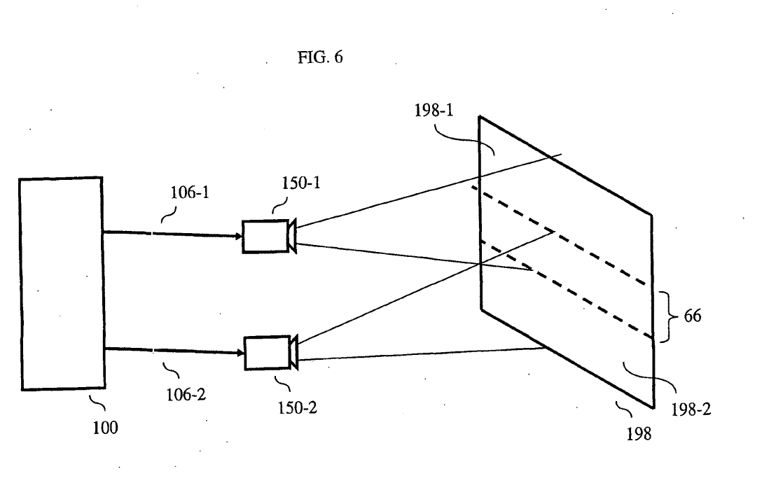

Turning briefly back to FIG. 2, projection screen 198 is made up of two smaller screen portions, 198-1 and 198-2. In accordance with the principles of the invention, the number and arrangement of the smaller screen portions is not limited to the horizontal dimension. As such, for this example, it is assumed that projection screen 198-is arranged vertically, e.g., screen 198-1 is above screen 198-2. In other words, the inventive concept supports not only a horizontal arrangement of projected outputs but also supports a vertical stacking of projected outputs. This is illustrated in FIG. 6. As can be observed from FIG. 6, M/E 105-1 (output signal 106-1) is associated with screen 198-1 (via projector device 150-1) and M/E 105-2 (output signal 106-2) is associated with screen 198-2 (via projector device 150-2). As shown in FIG. 6, and described further below, the output signals from each M/E create an overlap region 66 on projection screen 198.

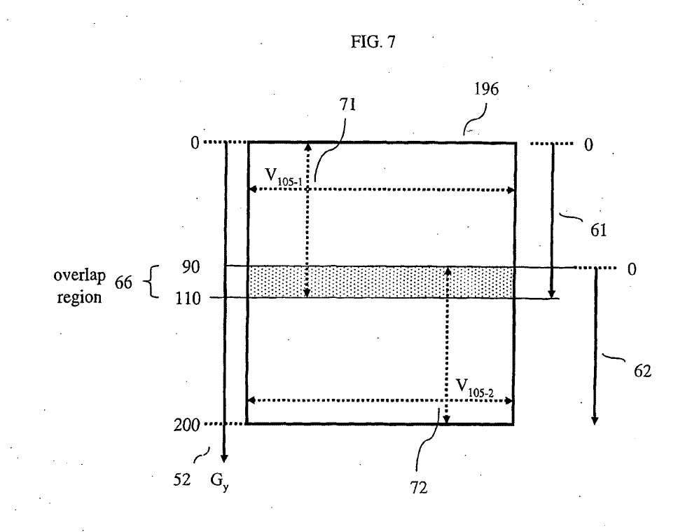

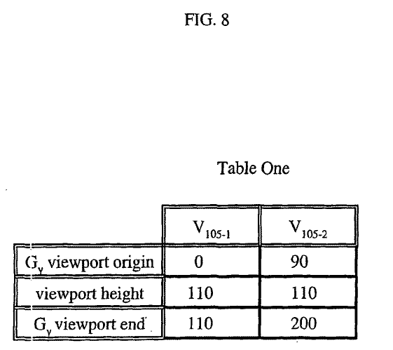

Returning to FIG. 3, in step 420, and in accordance with the principles of the invention, controller 180 determines a number of viewports into the global space such that (a) each viewport (or local space) is associated with one M/E and (b) viewports associated with adjacent screen portions overlap. The background input of each M/E is associated with its respective viewport. In this example, it is assumed that the amount of overlap is predefined at 10% and provided to controller 180, e.g., by an operator via a control panel (not shown) of video production switcher 100. Since there are only two M/Es in this example, controller 180 easily determines the viewports associated with each M/E as illustrated in FIG. 7. In particular, given the predefined associations between the M/Es and the screen portions of projection screen 198, M/E 105-1 is associated with a local space V₁₀₅₋₁ as represented by dotted double-headed arrows 71 (i.e., the top of the image) and M/E 105-2 is associated with a local space V₁₀₅₋₂ as represented by dotted double-headed arrows 72 (i.e., the bottom of the image). In this example, the width (not shown in FIG. 7) for each local space corresponds to the width of projection screen 198. However, the height of projection screen 198 is divided between two screen portions, 198-1 and 198-2, i.e., the height of each screen is 100 elements. Since the amount of overlap is 10%, the image from one projector device will extend 10 elements (100×10%) onto the adjacent screen. Thus, controller 180 determines for M/E 105-1 that V₁₀₅₋₁ starts at G_{y}=0 and extends to G_{y}=110; and determines for M/E 105-2 that V₁₀₅₋₂ starts at G_{y}=90 and extends to G_{y}=200. This is illustrated in FIG. 7 by y-dimension axis 61 of V₁₀₅₋₁ and y-dimension axis 62 of V₁₀₅₋₂. Thus, the viewports are created with overlapping edges. This is shown in FIG. 7 by overlap 7′ region 66, which is also represented by the stippling shown in the figure. Referring now to FIG. 8, the mappings between viewports and the global space is also shown in Table One. For example, the viewport for M/E 105-2, V₁₀₅₋₂, has an origin at G_{y}=90, a viewport height of 110 and, as a result, ends at G_{y}=200.

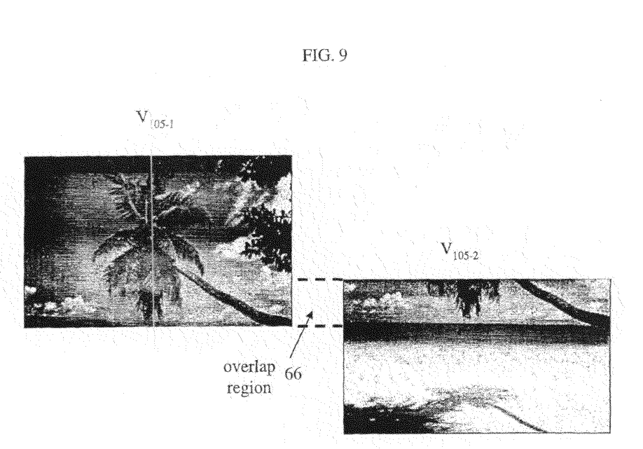

In step 425, flying video picture-in-pictures (PIPs) are keyed onto the background. In addition to known prior art methods of keying PIPs, another method is described in the co-pending patent application entitled “METHOD AND APPARATUS FOR DISPLAYING AN IMAGE WITH A PRODUCTION SWITCHER” filed on even date herewith to Casper et al. In step 430 of FIG. 3, controller 180 soft crops the identified overlap regions, e.g., overlap region 66, in image-store 196. Other than the inventive concept, soft crops, or edge blending, is known in the art. Typically, each side of the overlap region has its own independent softness adjustment, which translates into the width of the overlap area. It should be noted that additive mixing of video signals themselves is limited to a maximum intensity. However, the additive mixing of the light from the projectors is not limited—so care must be taken to use the right algorithm to produce the soft crop, so that inadvertent amplitude peaks and edge effects are not created. Furthermore, compensations must be made for a black level (a DC offset) in the non-blended regions since the ‘black’ output from a projector is not really black and any overlapping ‘blacks’ are brighter than non-overlapping blacks. Finally, in step 435, that portion of image 301 associated with V₁₀₅₋₁ is provided to M/E 105-1 via signal path 182, which is representative of the above-noted switching matrix; and that portion of image 301 associated with V₁₀₅₋₂ is provided to M/E 105-2, also via signal path 182. As such, each M/E projects their respective portion of the background image with the requisite overlap via their associated projection devices onto the projection screen. This is illustrated in FIG. 9 for image 301. It should be noted that no blending is shown in FIG. 9, only an illustration of the overlapping viewports.

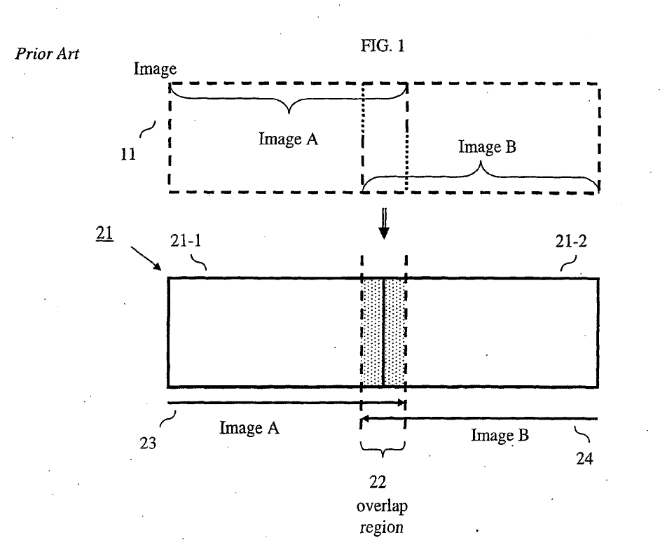

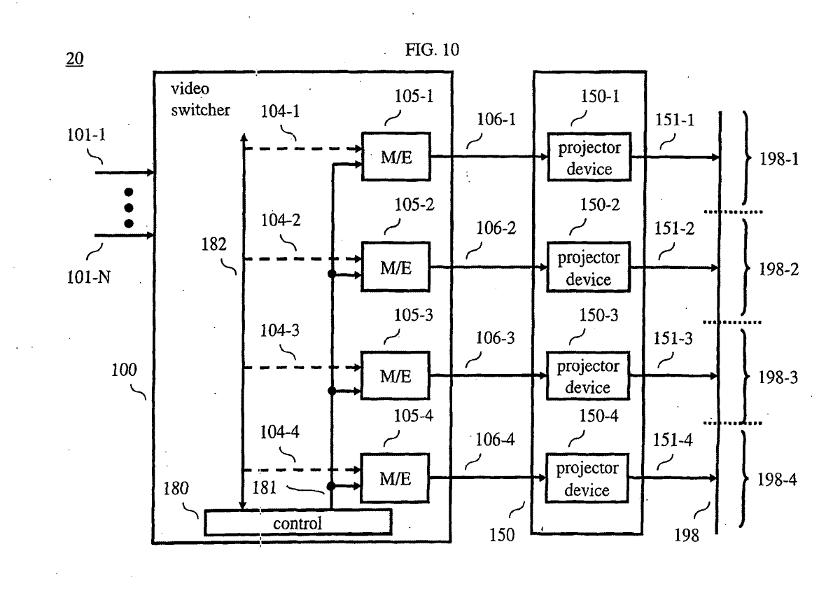

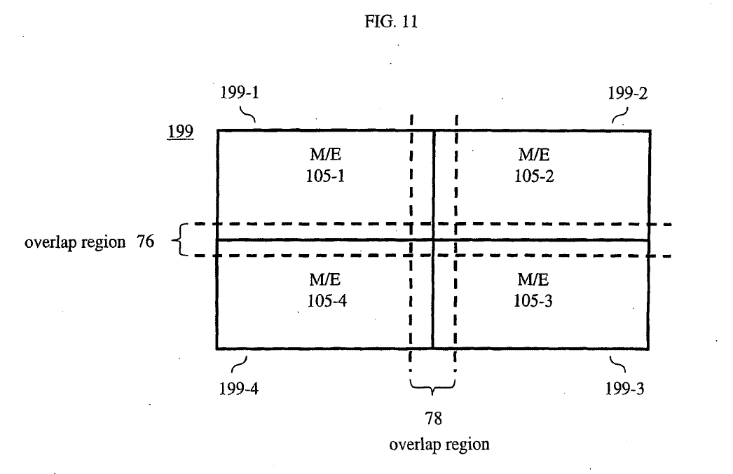

Referring now to FIG. 10, a more general illustration of the inventive concept is shown. Video system 20 of FIG. .10 is similar to video system 10 of FIG. 1, except that video system 20 now includes four M/E (M/E 105-1, M/E 105-2, M/E 105-3 and M/E 105-4), where each M/E is associated with a respective projector device (projector device 150-1, projector device 150-2, projector device 150-3, and projector device 1504) for projecting video/images onto wide-extended screen 199 having four screen portions (199-1, 199-2, 199-3 and 199-4). FIG. 11 shows mappings of the M/Es s of FIG. 10 to the multiple portions in accordance with the principles of the invention. As can be observed from FIG. 11, the inventive concept supports top/bottom and left/right soft crops, i.e., the rectangular stacking of projected outputs.

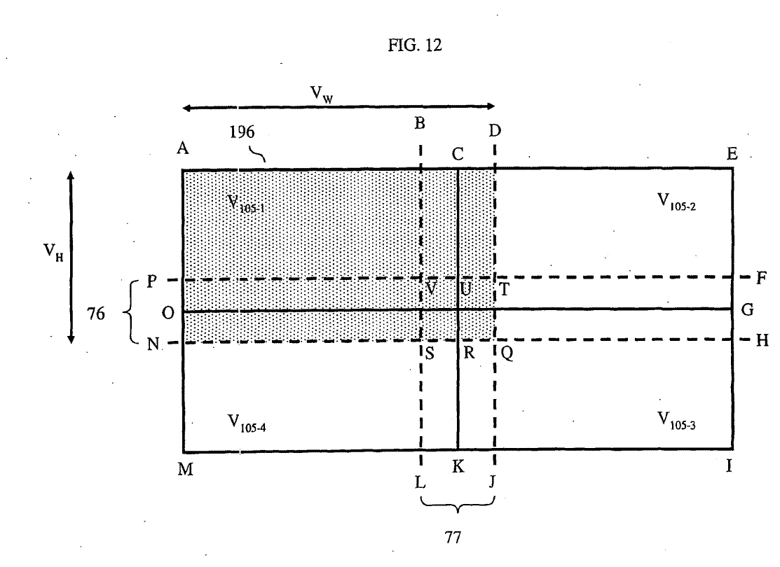

Referring again to the flowchart of FIG. 3, but in more abbreviated form, in step 405 of FIG. 3, controller 180 of FIG. 10 receives an image for display on the projection screen. In step 410 of FIG. 3, controller 180 of FIG. 10 stores the image in image-store 196. In step 415, controller 180 of FIG. 10 maps the image into a global space as described above. In step 420, and in accordance with the principles of the invention, controller 180 of FIG. 10 determines a number of viewports into the global space such that (a) each viewport (or local space) is associated with one M/E and (b) viewports associated with adjacent screen portions overlap. Again, in this example the background input of each M/E is associated with its respective viewport and it is assumed that the amount of overlap is predefined at 10%. Since there are four M/Es in this example, controller 180 easily determines the four viewports associated with each M/E as illustrated in generic fashion in FIG. 12.

In particular, it is assumed that the large rectangle AEIM of FIG. 12 is the complete image stored in image-store 196. In addition, given the predefined associations between the M/Es and the screen portions of projection screen 199 as shown in FIG. 11, M/E 105-1 is associated with local space V₁₀₅₋₁ (i.e., the top left of the image), M/E 105-2 is associated with local space V₁₀₅₋₂ (i.e., the top right of the image), M/E 105-3 is associated with local space V₁₀₅₋₃ (i.e., the bottom right of the image), and M/E 105-4 is associated with local space V₁₀₅₋₄ (i.e., the bottom left of the image). Further, it is assumed that the stippled section of FIG. 12 corresponding to rectangle ADQN represents the viewport V₁₀₅₋₁, and is of dimensions V_{H} by V_{W}. The right side overlap region is the rectangle BDQS and the bottom overlap region is the rectangle PTQN. If the overlap region is 10% of the width (and height) of the image, then the size of the rectangle AEIM will be 1.9V_{H} by 1.9V_{w} (which of course is smaller than 2V_{H}×2V_{W}). It should be noted that a content creator designing such a background needs to be aware of this. Of relevance here is that the controller 180 determines the size of the viewports based on this. As such, given a point of origin A in FIG. 12 and the desired size of the overlap region, controller 180 easily calculates the dimensions of the four viewports V₁₀₅₋₁ (rectangle ADQN), V₁₀₅₋₂ (rectangle BEHS), V₁₀₅₋₃ (rectangle VFIL) and V₁₀₅₋₄ (rectangle PTJM).

In step 425, PIPs are keyed onto the background. In step 430 of FIG. 3, controller 180 of FIG. 10 soft crops the identified overlap regions, e.g., overlap regions 76 and 77, in image-store 196. Finally, in step 435, the portions of the images associated with each viewport are provided to the respective M/Es via signal path 182. As such, each M/E projects their respective portion of the background image with the requisite overlap via their associated projection devices onto the projection. screen.

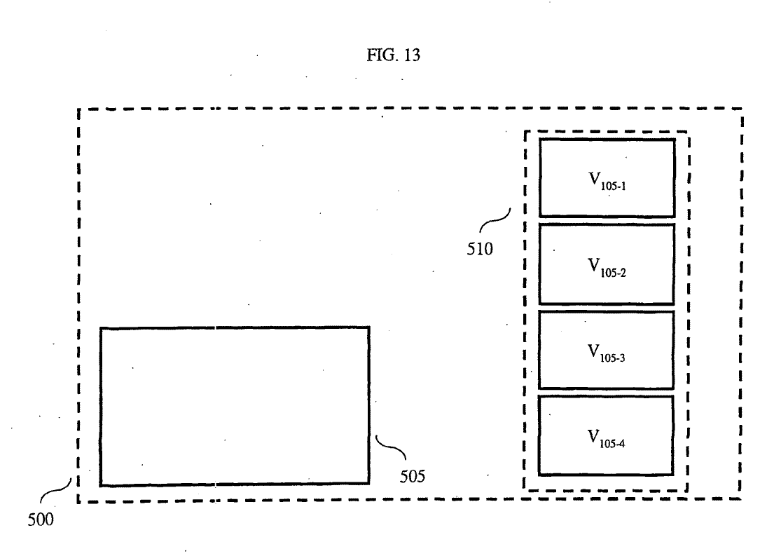

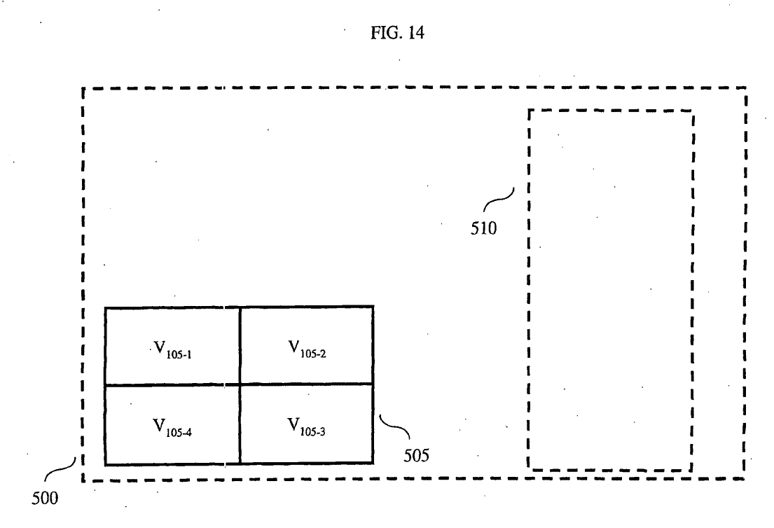

In accordance with the principles of the invention, a graphical user interface (GUI) can be implemented for providing a graphical means for defining the spatial relationship between the global coordinate space and the various local M/E spaces. This allows an operator to take a large background graphic and route its sections to M/E according to the geometric relationship of the output projectors. The operator is thus insulated from having to think about overlapping edges since this is calculated by the software layer (e.g., controller 180 of FIGS. 2 or 10) based on the defined. relationship of the projectors. This GUI can be a part of the above-noted control panel (e.g., a personal computer having a display). An abstract representation of such a GUI is shown in FIGS. 13 and 14. Turning first to FIG. 13, a screen 500 comprises graphical elements 505 and 510. Graphical element 505 proportionally represents the image for display in terms of length and width. Graphical element 510 represents the viewports available for assignment to the image. In accordance with the principles of the invention, each viewport is associated with one M/E. The GUI interface enables the dragging and dropping of one or more of the viewports shown in graphical element 510 into graphical element 505. Thus, the operator can specify the mapping between each M/E and the image. This is illustrated in FIG. 14, which illustrates the assignment of particular viewports to the image.

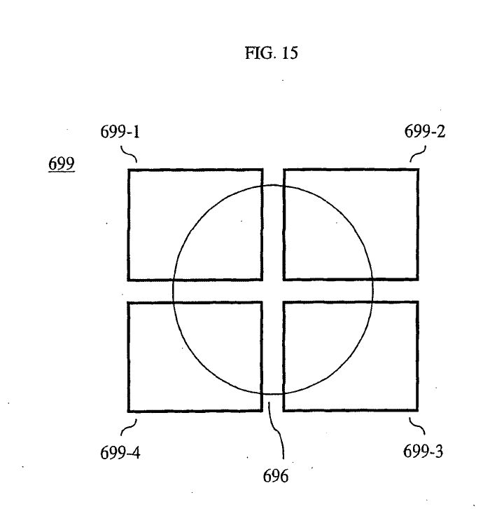

In accordance with the principles of the invention, viewports can also be defined to be non-overlapping. This is illustrated in FIG. 15. A projection screen 699 comprises four smaller screen portions, 699-1, 699-2, 699-3 and 699-4, which are arranged to have gaps between them. In this example, the background is a large circle 696. The goal is to preserve the geometric integrity of the background, relying on the eye to integrate and ignore the dark spaces between the bright illuminated screen portion. As such, instead of a there being a blending region, controller 180 determines the viewports such that there are gaps between them.

As described above, controller 180 performed the blending. However, and in accordance with the principles of the invention, the flow chart of FIG. 4 can be modified such that the blending step 430 is performed by each respective M/E after it receives its portion of the image. In addition, another place that the blending can be performed is in the output circuitry of an auxiliary (aux) bus (not shown above). That is to say, the output of each M/E can be outputted directly without soft crop, so it can be seen on a video monitor, and/or routed to an aux bus which is configured to apply a soft crop to one or more edges. This latter scheme has several advantages: (a) it reduces complexity in the M/E (which are already very complicated circuits) and (b) it allows the outputs to be monitored clearly. If two adjacent edges are soft-cropped, then each would appear as an incomplete image in a video monitor. Viewing the un-cropped output on each monitor is much more desirable.

As described above, a video production switcher in accordance with the principles of the invention facilitates not only the vertical stacking of images (or viewports) but also the arrangement of four (or more) projectors to form a quadrilateral having rectangular projection areas (e.g., vertically stacked viewports and horizontally stacked viewports). Where the prior arrangements described in the background have proved effective in concert auditoriums and theatres, etc., a video production switcher in accordance with the principles of the invention would be very effective in spaces such as building atriums (e.g., hotels), cathedral-like churches, shopping malls, etc., because of the ability to vertically stack the images.

It should be noted that although the inventive concept is described in the context of a particular number of M/E devices, projectors and screens, the inventive concept is not so limited and other numbers, smaller and/or larger, in any combination may be used for the respective elements. For example, the inventive concept is also applicable to a display comprising a number of screens, i.e., a multi-screen display. In addition, although the inventive concept was described in the context of a vertical arrangement (e.g., FIG. 6) and a vertical and horizontal arrangement (e.g., FIG. 12); the inventive concept is also applicable to a horizontal arrangement.

As such, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one or more integrated circuits (ICs). Similarly, although shown as separate elements, any or all of the elements may be implemented in a stored-program-controlled processor, e.g., a digital signal processor, which executes associated software, e.g., corresponding to one or more of the steps shown in, e.g., FIG. 3, etc. It is therefore to be understood that numerous modifications may be made to the illustrative embodiments and that other arrangements may be devised without departing from the spirit and scope of the present invention as defined by the appended claims.

1. A method for use in a video production switcher for providing video signals for use in displaying an image on a display, the method comprising:
storing an image; and
mapping viewports to the stored image for use in displaying the image, wherein at least two viewports overlap.

2. The method of claim 1, wherein the mapping step includes:
mapping the stored image to a global space, the global space associated with the display;
determining a number of viewports in the global space, each viewport associated with a mix effects unit, a portion of the stored image and a portion of the display; and wherein those viewports associated with adjacent portions of the display overlap.

3. The method of claim 1, further comprising:
blending a portion of the stored image that is within a region where the viewports overlap.

4. The method of claim 3, wherein a mix effects unit performs the blending step.

5. The method of claim 3, wherein an auxiliary bus performs the blending step.

6. The method of claim 1, further comprising the step of:
projecting those portions of the stored image associated with each viewport onto respective portions of the display.

7. The method of claim 6, wherein the projecting step projects the stored image such that at least two of the viewports appear vertically stacked.

8. The method of claim 6, wherein the projecting step projects the stored image such that the viewports appear vertically and horizontally stacked.

9. The method of claim 1, further comprising the step of:
assigning a number of viewports to a particular portion of the image.

10. The method of claim 9, wherein the assigning step comprises:
displaying a graphical user interface which comprises a representation of the image and a representation of each of the viewports;
wherein the graphical user interface allows the representation of each viewport to be arranged within the representation of the image for assignment to a particular portion of the image.

11. Apparatus comprising:
a number of mix effects units, each mix effects unit providing a video output signal for use in displaying images on a display;
a memory for storing an image; and
a controller for (a) mapping the stored image to a global space, the global space associated with the display, and (b) for determining a number of viewports in the global space, each viewport associated with one of the number of mix effects units, a portion of the stored image and a portion of the display; and wherein those viewports associated with adjacent portions of the display overlap.

12. The apparatus of claim 11, wherein the controller blends a portion of the stored image that is within a region where the viewports overlap.

13. The apparatus of claim 12, wherein each mix effects unit blends a portion of the stored image that is within a region where the viewports overlap.

14. The apparatus of claim 11, further comprising
a number of projector devices, each projector device associated with one of the mix effects units, wherein each projector device is responsive to the video output signal from its mix effects unit for displaying an image on the display.

15. The apparatus of claim 14, further comprising the display, which includes a number of portions, wherein each portion is mapped to one of the mix effects units.

16. The apparatus of claim 15, wherein the number of portions are arranged vertically or horizontally.

17. The apparatus of claim 15, wherein the number of portions are arranged vertically and horizontally.

18. The apparatus of claim 11, further comprising
a display for displaying a graphical user interface which comprises a representation of the image and a representation of each of the viewports;
wherein the graphical user interface allows the representation of each viewport to be arranged within the representation of the image for assignment to a particular portion of the image.
